(19) United States
(12) Patent Application Publication
(10) Pub. No.: US 2008/0136077 A1
(43) Pub. Date: Jun. 12, 2008

(54) Bar clamp with ratchet mechanism and linkage

(76) Inventor: Ching-chen Yang, Taichung (TW)

Correspondence Address: SAM CHEN, 7F-1, 293, ROOSEVELT ROAD, SEC 3, TAIPEI, omitted

(21) Appl. No.: 11/924,621

(22) Filed: Oct. 26, 2007

(30) Foreign Application Priority Data
Dec. 6, 2006 (TW) 095221464

(51) Int. Cl. B25B 5/14

(52) U.S. Cl. 269/6

(57) ABSTRACT

A bar clamp includes a slide bar having forward ratchet teeth; first and second moveable jaws slidably put on the slide bar; a slotted trigger handle; first and second linkages at opposite sides of the slide bar in a cavity of the second moveable jaw, each linkage comprising first, second, and third links wherein one ends of the links are pivotably secured together, and the other ends thereof are pivotably secured to the second moveable jaw, the trigger handle, and the slide bar respectively; a release lever fastened in the slot and comprising a well at one end, a trigger at the other end, and a resilient member interconnecting the slot and the bottom of the trigger; and a pivotal pawl comprising pawl teeth at one end being in mesh with one end of the ratchet teeth, and a projection at the other end being moveably received in the well.

### BACKGROUND OF THE INVENTION

1. Field of Invention

The invention relates to bar clamps and more particularly to a bar clamp having a ratchet mechanism and a linkage including three pivotably joined links with improved characteristics including increased clamping force and durability.

2. Description of Related Art

A conventional bar clamp is shown in FIGS. 1, 2 and 3 and comprises an L-shaped slide bar 1 having a fixed jaw 11 at an open end of its horizontal portion; a moveable jaw carrier 3 slidably put on the vertical portion of the slide bar 1, the moveable jaw carrier 3 including an extension 31 at an open end, the extension 31 having a transverse through hole (not numbered) and ratchet teeth 311 along a lower edge; and a moveable jaw section, trigger handle, and release lever assembly 2.

The moveable jaw section, trigger handle, and release lever assembly 2 comprises a slotted trigger handle 21 including two side walls 211; and an elongated release lever 26 having a V-shaped tooth 261 at one end, the release lever 26 being pivotably secured to an internal slot of the trigger handle 21 by a pin (not numbered) and a torsion spring (not numbered) having one end affixed to the slot of the trigger handle 21 and the other end affixed to the release lever 26, the release lever 26 being partially disposed in the trigger handle 21 in an inoperative position.

The moveable jaw, trigger handle, and release lever assembly 2 further comprises a moveable jaw section comprising an inverted U-shaped moveable jaw 22 including two sides 221 having an elongated slot 222; two opposite moveable members 25 having an elongated slot 252 and teeth 251 on one side of an inner recess; two opposite gears 24 having teeth 241 on a portion of its edge, the teeth 241 being in mesh with the teeth 251; and a pivot pin 23 inserted through, from one side, one slot 222, one slot 252, a through hole (not numbered) of one gear 24, a through hole (not numbered) of one side wall 211, the through hole of the extension 31 and through at the other side, a through hole (not numbered) of the other side wall 211, a through hole (not numbered) of the other gear 24, the other slot 252, and the other slot 222 with the tooth 261 being in mesh with the ratchet teeth 311.

An operation of the conventional bar clamp will be described in detail below by referring to FIGS. 2 and 3 specifically. A workpiece (not shown) is held between the fixed jaw 11 and the moveable jaw 22 by moving the moveable jaw carrier 3 toward the fixed jaw 11. Next, a user squeezes the trigger handle 21 in a direction toward the fixed jaw 11 to rotate the pivot pin 23 which in turn rotates the gears 24. Also, the moveable members 25 move toward the fixed jaw 11. As a result, the moveable jaw 22 incrementally advances in the direction of the fixed jaw 11 to clamp the workpiece.

But this is unsatisfactory for the purpose for which the invention is concerned for the following reasons:

The number of each of the teeth 241 and 251 is four. Thus, its engagement is structurally weak. It is often that the teeth are broken after a short period time of use. Moreover, a substantial area of the trigger handle 21 is occupied by the release lever 26. Hence, force exerted by gripping the trigger handle 26 in the clamping operation is greatly reduced. This may interfere with the operation. Thus, the need for improvement still exists.

### SUMMARY OF THE INVENTION

It is therefore one object of the invention to provide a bar clamp having a ratchet mechanism and a linkage including three pivotably joined links so as to increase clamping force and to be durable.

The above and other objects, features and advantages of the invention will become apparent from the following detailed description taken with the accompanying drawings.

### BRIEF DESCRIPTION OF THE DRAWINGS

FIG. 1 is an exploded view of a conventional bar clamp;

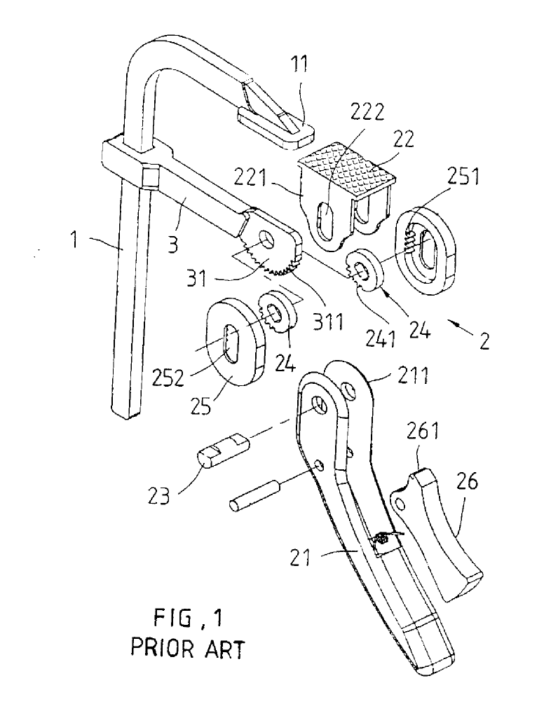

FIG. 2 is a schematic side elevation of the assembled bar clamp;

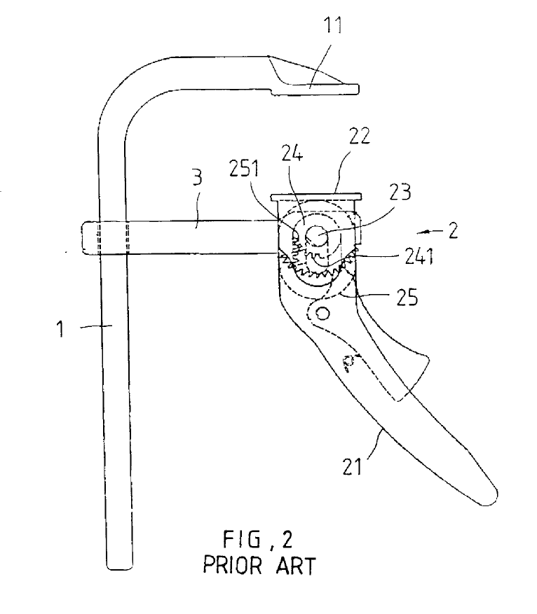

FIG. 3 is a schematic sectional view of the moveable jaw, trigger handle, and release lever assembly showing a clamping operation;

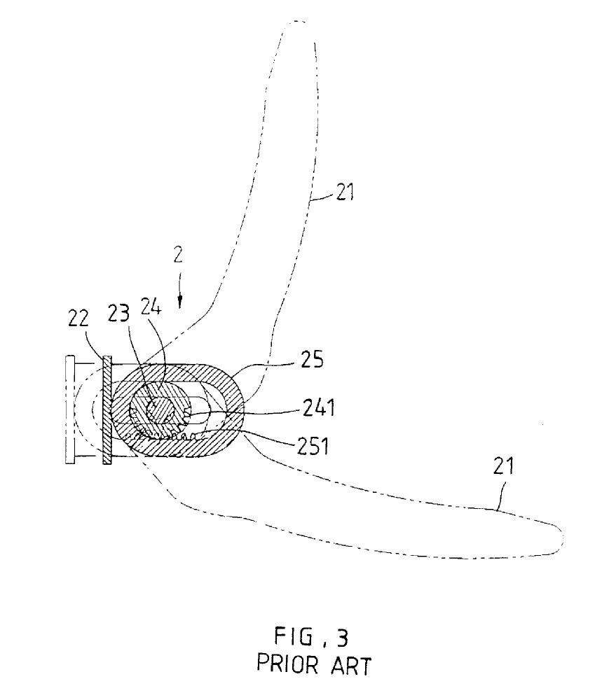

FIG. 4 is a schematic sectional view of a preferred embodiment of bar clamp according to the invention;

FIG. 5 is a view similar to FIG. 4 where the trigger handle is pivoting toward the second moveable jaw in a clamping operation;

FIG. 6 is a view similar to FIG. 5 where the workpiece has been clamped; and

FIG. 7 is a view similar to FIG. 6 where a workpiece release and trigger handle returning operation is shown.

### DETAILED DESCRIPTION OF THE INVENTION

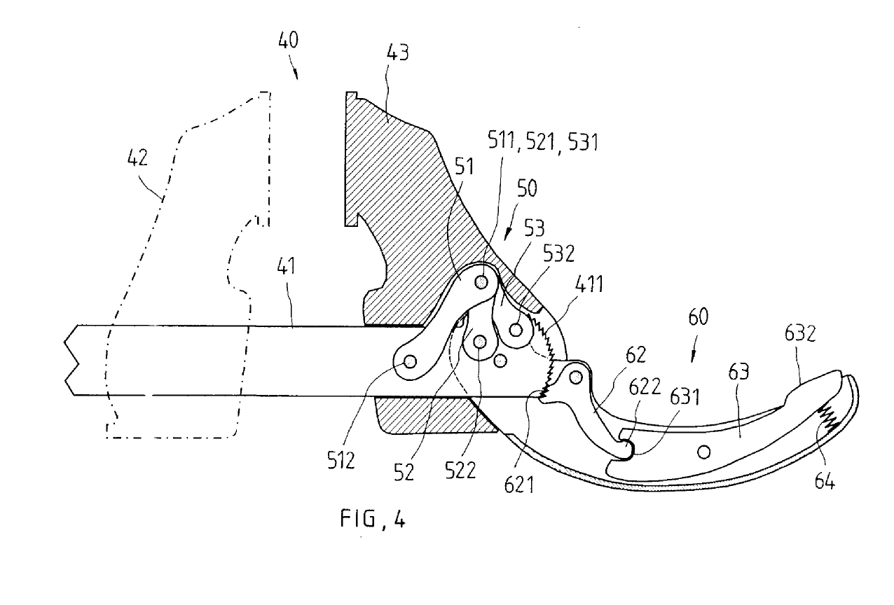

Referring to FIGS. 4 to 7, a bar clamp 40 in accordance with a preferred embodiment of the invention is shown. The bar clamp 40 comprises the following components.

A slide bar 41 has a forward end formed with ratchet teeth 411. A second moveable jaw 43 is slidably mounted on the slide bar 41 proximate the ratchet teeth 411. A first moveable jaw 42 is slidably put on the slide bar 41 behind the second moveable jaw 43.

Two sets of linkages 50 are provided at opposite sides of the slide bar 41 in a cavity of the second moveable jaw 43. The linkage 50 comprises a first link 51, a second link 52, and a third link 53. One end 511 of the first link 51, one end 521 of the second link 52, and one end 531 of the third link 53 are pivotably secured together. The other end 512 of the first link 51 is pivotably secured to the second moveable jaw 43. The other end 522 of the second link 52 is pivotably secured to one end of a trigger handle 61. The other end 532 of the third link 53 is pivotably secured to the forward end of the slide bar 41.

A release lever and trigger handle assembly 60 comprises the trigger handle 61 and a release lever 63. The curved, slotted trigger handle 61 has one end pivotably secured to the forward end of the slide bar 41. The release lever 63 is pivotably secured to an internal slot of the trigger handle 61 by a pin (not numbered) and a helical spring 64 having one end affixed to the slot of the trigger handle 61 and the other end affixed to the bottom of a forward trigger 632 of the release lever 63. The release lever 26 is substantially disposed in the trigger handle 61 in an inoperative position. This has the benefit of not interfering with a squeezing by the hand in a clamping operation as detailed later.

A pivotal pawl 62 has one end formed with V-shaped teeth 621 which are in mesh with one end of the ratchet teeth 411 in the inoperative position, and the other end formed with a shaped projection 622 received in a well 631 at a rear end of the release lever 63.

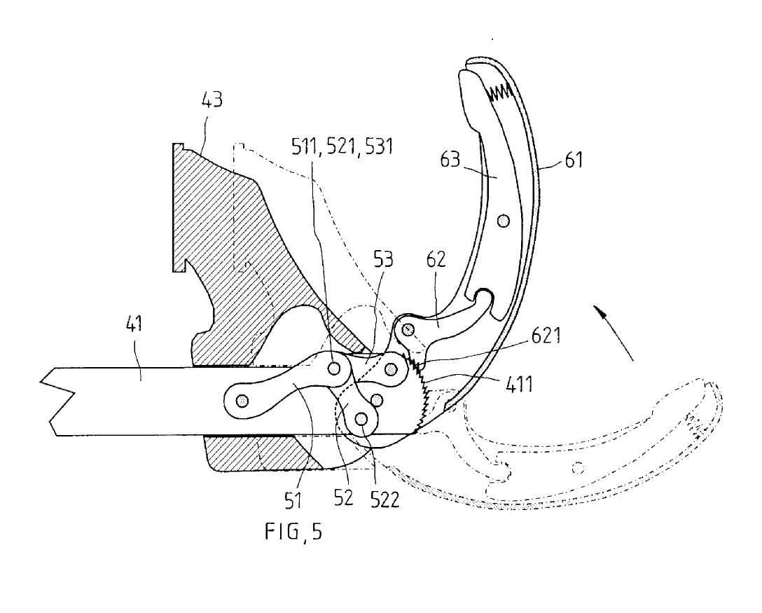

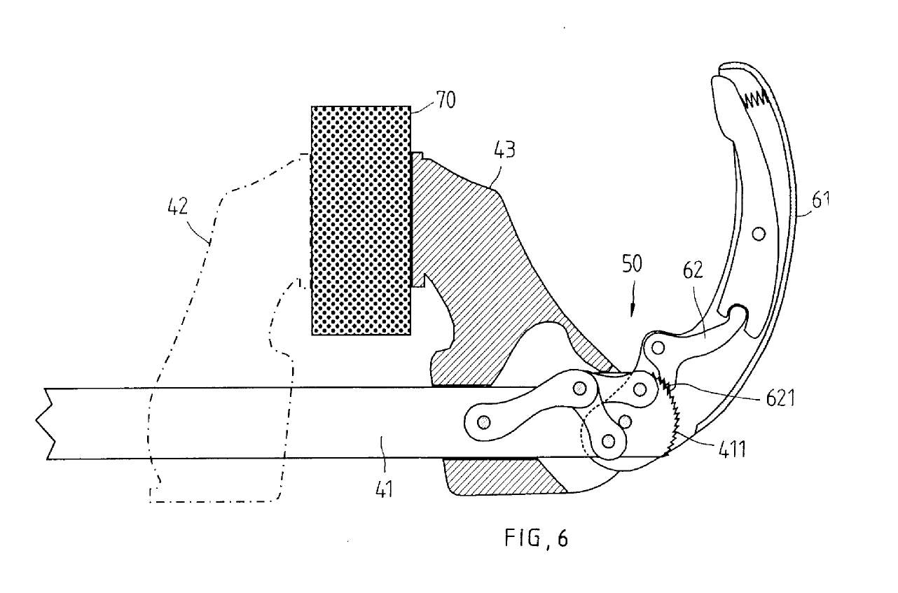

A clamping operation of the invention will be described in detail below. A workpiece 70 is held between the second moveable jaw 43 and the first moveable jaw 42 by moving the first moveable jaw 42 toward the second moveable jaw 43. Next, a user squeezes the trigger handle 61 in a direction toward the second moveable jaw 43 by counterclockwise pivoting as indicated by arrow (see FIG. 5). The other end 522 of the second link 52 thus pivotably moves downward as it is pivotably secured to the trigger handle 61 (see FIG. 5). Also, the first link 51 pivots clockwise and the third link 53 pivots counterclockwise respectively. As such, a distance between the other end 512 of the first link 51 and the other end 532 of the third link 53 is increased. Hence, the second moveable jaw 43 incrementally moves toward the first moveable jaw 42 because the second moveable jaw 43 is pivotably secured to the other end 512 of the first link 51 and the slide bar 41 is pivotably secured to the other end 532 of the third link 53. The movement of the second moveable jaw 43 will stop when the teeth 621 move to the other end of the ratchet teeth 411 (see FIG. 6). As an end, the workpiece is securely clamped between the second moveable jaw 43 and the first moveable jaw 42. Note that a backward movement of the teeth 621 from the position shown in FIG. 6 to the position shown in FIG. 4 is prevented due to the nature of ratchet.

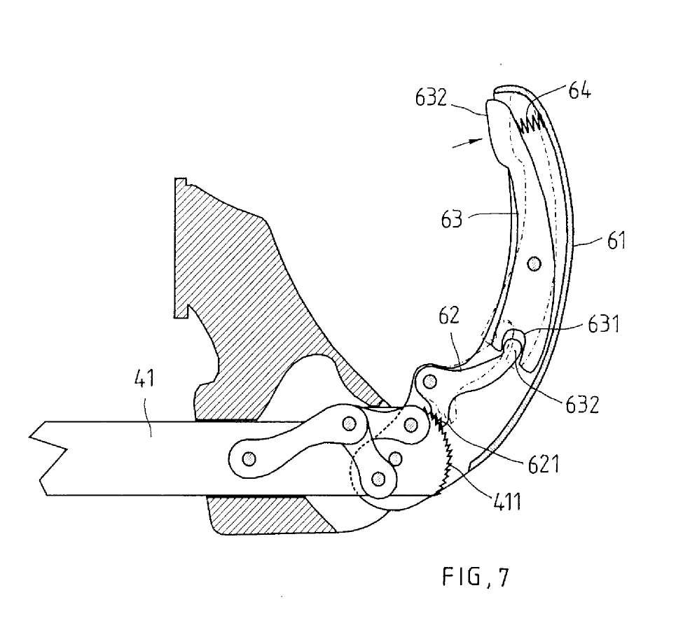

A workpiece release operation of the invention will be described in detail below by referring to FIG. 7 specifically. A user may press the trigger 632 to counterclockwise pivot the projection 622 and thus clockwise pivot the teeth 621. As such, the teeth 621 and the ratchet teeth 411 are disengaged. The user may then slide the second moveable jaw 43 along the slide bar 41 toward a direction away from the first moveable jaw 42. As a result, the workpiece 70 is unfastened.

While the invention herein disclosed has been described by means of specific embodiments, numerous modifications and variations could be made thereto by those skilled in the art without departing from the scope and spirit of the invention set forth in the claims.

What is claimed is:

1. A bar clamp comprising:
a slide bar having ratchet teeth formed along a forward end;
a first moveable jaw slidably put on the slide bar;
a trigger handle having a lengthwise slot;
a second moveable jaw slidably mounted on the forward end of the slide bar;
first and second linkages disposed at opposite sides of the slide bar in a cavity of the second moveable jaw, each of the first and the second linkages comprising a first link, a second link, and a third link wherein one end of the first link, one end of the second link, and one end of the third link are pivotably secured together, the other end of the first link is pivotably secured to the second moveable jaw, the other end of the second link is pivotably secured to one end of the trigger handle, and the other end of the third link is pivotably secured to the forward end of the slide bar;
a release lever pivotably fastened in the slot and comprising a well at one end, a trigger at the other end, and a resilient member interconnecting the slot and the bottom of the trigger; and
a pivotal pawl comprising pawl teeth at one end, the pawl teeth being in mesh with one end of the ratchet teeth in an inoperative position, and a projection at the other end, the projection being shaped to moveably receive in the well;
whereby holding a workpiece between the first moveable jaw and the second moveable jaw and pivoting the trigger handle toward the second moveable jaw will increase a distance between the other end of the first link and the other end of the third link for incrementally moving the second moveable jaw toward the first moveable jaw to clamp the workpiece until the pawl teeth move to the other end of the ratchet teeth; and
whereby pressing the trigger will pivot the pawl to cause the projection to partially clear the well and disengage the pawl teeth from the ratchet teeth, and sliding the second moveable jaw to move away from the first moveable jaw will unfasten the workpiece.

2. The bar clamp of claim 1, wherein the resilient member is a helical spring.
